(19) United States
(12) Patent Application Publication
(10) Pub. No.: US 2012/0072467 A1
(43) Pub. Date: Mar. 22, 2012

(54) General Map Web Interface

(75) Inventors: David A. Kiraly, Fort Wayne, IN (US); Manjari Bhargava, Fort Wayne, IN (US); Gregory M. Jewell, Fort Wayne, IN (US); Benjamin C. Scarborough, Fort Wayne, IN (US)

(73) Assignee: RAYTHEON COMPANY, Waltham, MA (US)

(21) Appl. No.: 13/225,746

(22) Filed: Sep. 6, 2011

Related U.S. Application Data
(60) Provisional application No. 61/385,119, filed on Sep. 21, 2010.

(51) Int. Cl. G06F 17/30; G06F 9/44

(52) U.S. Cl. 707/805; 719/328; 707/E17.018

(57) ABSTRACT

A data processing system including one or more geographic information systems (GISs) and one or more application programs, in which a common interface supports communication between multiple application programs and multiple GISs. The application programs and GISs may be implemented in different programming languages. Communication may occur in the same physical computer, or locally, or over an Internet.

### FIELD OF THE INVENTION

This application relates to Geographic Information Systems (GISs) and more particularly to a method and apparatus for interfacing a plurality of GIS's with a pplurality of application programs.

### BACKGROUND OF THE INVENTION

As is known in the art, a geographic information system (GIS) such as Google Earth integrates hardware, software, and data for capturing, managing, analyzing, and displaying all forms of geographically referenced information. In the simplest terms, a GIS is the merging of cartography, statistical analysis, and database technology. GIS systems are used for many purposes, including cartography, remote sensing, land surveying, public utility management, natural resource management, geography, urban planning, emergency management, navigation, and localized search engines.

As is also known in the art, an application program may require the capability to interchange data between itself and a GIS. For that purpose, the application program requires an application programming interface (API) to define the format in which geographic and graphical data elements will be transferred to and from the GIS.

Many different GIS's can be used for displaying and interacting with geographical data. For example, a typical application program may have a requirement to communicate with three different GIS's, such as Google Earth, Falcon View, and OpenMap. In that case, a different APIwould be required for each GIS. That would be a poor design, requiring separate software development for each GIS used with the application program.

### SUMMARY OF THE INVENTION

In accordance with the present invention, a common interface referred to as a general map web interface (GMWI) is described. The GMWI defines the format and structure of data communicated between an application program and a GIS. The GMWI has been designed with sufficient generality to interface with any GIS. A software element called a map adapter within a GIS and a software element called a map injector within an application program support this common interface (i.e. the GMW interface). Thus, any map adapter can be swapped out and replaced with another map adapter without changing any map injector code, and any map injector can be swapped out and replaced with another map injector without changing any map adapter code.

An advantage of the GMWI is that any application program can use the GMWI to communicate with any GIS via its map adapter, because they both support the same interface. For example, the effects management tool (EMT), an application program developed by the US Army and the US Marine Corps, can read information from a database and transfers this information via the GMWI to a GIS, allowing display of unit symbols, battlefield geometries, fire support coordination measures, and target symbols. Therefore, as can be seen, using the GMWI, the EMT can communicate with any GIS, without implementation change.

An additional advantage of the GMWI is that it is web based. Thus, application programs running on other systems can inject their data onto a map via the Internet, even if they are not on the same server or even in the same location as the GIS. This allows for data sharing between different local or remote systems.

An additional advantage of the GMWI is that it is programming language independent. Thus application programs written in one language can communicate with GIS systems written in another language. Further, more than one application program or more than one GIS can all intercommunicate, even when the various application programs are written in different languages and the various GISs are written in different programming languages.

The General Map Web Interface (GMWI) is a set of web services that define a common set of Application Programming Interfaces (APIs). These APIs support two different functional roles: geographic information and graphical information.

The geographic information is displayed by a Geographic Information System (GIS). The geographic API, part of the GMWI, will inherit a data structure such as Open Geospatial Consortium (OGC) data structure, which is an industry standard. What makes the API in this invention unique is that it is done using web services which can be deployed in many different environments, i.e. JBoss, Tomcat, .NET, Axis Server, etc.

The graphical information is used to define graphical user interface (GUI) components to be displayed by the GIS. The software within the GIS, which accepts the GUI components, will be referred to as a map adapter. Thus, the map adapter will receive GUI components from the map injector. GUI components may include data trees, popup menus, menu bars, toolbars, status lines, and informational boxes, as well as other GUI components.

### BRIEF DESCRIPTION OF THE DRAWINGS

The foregoing features of this invention, as well as the invention itself, may be more fully understood from the following description of the drawings in which:

FIG. 1 is a block diagram of an architecture for a general map web interface (GMWI);

FIG. 1A is a block diagram showing the relationship of a map injector and a map adapter to a data processing system.

FIG. 2 is a block diagram of a plurality of map injectors interfacing to a map adapter;

FIG. 3 is a block diagram illustrating GMWI employed in a system;

FIG. 4 is a block diagram illustrating a GMWI in a thin client system;

FIG. 5 is a block diagram illustrating multiple language support in a GMWI;

FIG. 6 is a block diagram illustrating the GMWI interface as seen by a developer;

FIG. 7 is a block diagram illustrating elements of a GMWI;

FIG. 8 is a flow diagram illustrating a process for adding a circle geometry to a map;

FIG. 8A is a flow diagram illustrating a process which allows a user to access a circle geometry on a map;

FIG. 8B is a flow diagram illustrating a process for swapping out map adapters while maintaining the current map injector; and

FIG. 9 is a block diagram showing an exemplary hardware and operating environment of a suitable computer for use with embodiments of the invention.

### DETAILED DESCRIPTION OF THE PREFERRED EMBODIMENTS

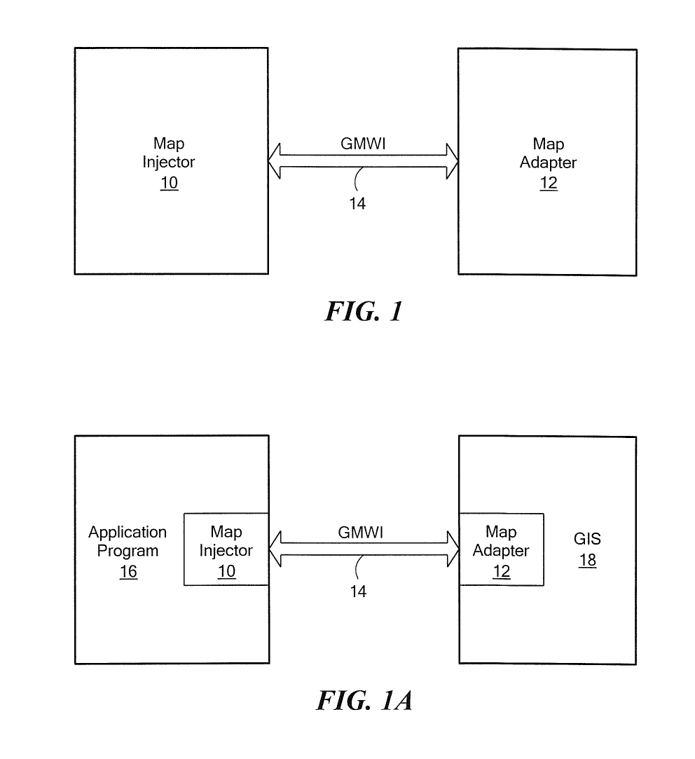

Referring now to FIG. 1, the general map web interface (GMWI) 14 defines an interface between two different software elements: (1) a map injector 10; and (2) a map adapter 12. The bi-directional arrow 14 in the figure shows that two way communication between the map injector and map adapter is compliant with the GMWI format. The map injector is a data provider for the map adapter. The map adapter processes the data being sent from the map injector. The GMWI also defines an interface from the map adapter back to the map injector, which allows the map injector to be notified of any changes or actions that the map adapter has performed or of any user actions, such as clicking on an object in the GIS or clicking on a menu item, performed on the map adapter.

Referring now to FIG. 1A, the map injector 10 and map adapter 12 provide a means for an application program 16 to interface with a GIS 18. Specifically, the map injector is integrated into the application program and the map adapter is integrated into the GIS. Communication between the application program and the GIS flows thru the map injector and the map adapter.

The architecture described above supports various configurations of application programs and GISs, some of which are described below.

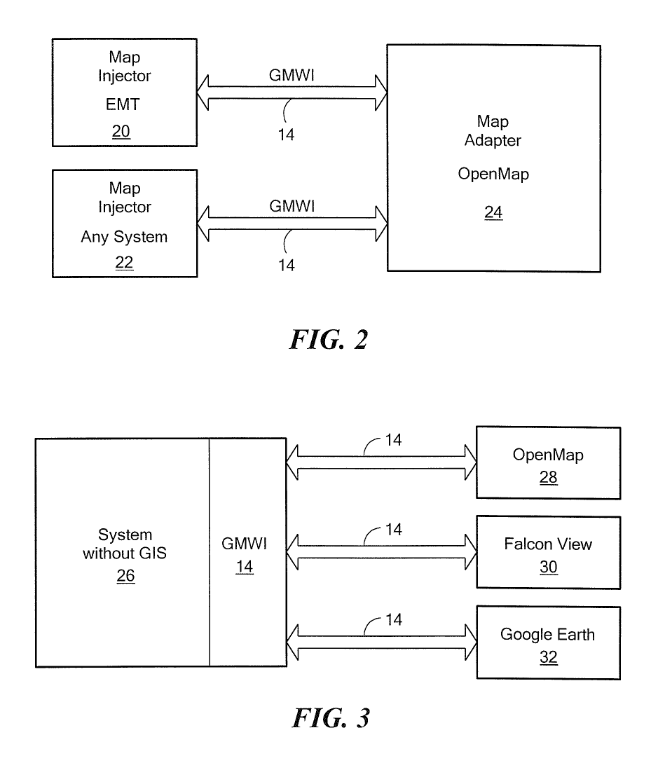

Several map injectors can interface with a single map adapter, as shown in FIG. 2. In that figure, a map injector 20 is configured to receive data from an Effects Management Tools (EMT) and provide the data to an OpenMap Map Adapter 24 via the GMWI 14. Any system 22 that incorporates a map injector implemented using the GMWI can now use the OpenMap Map Adapter to display its geographical data as well. This allows for the sharing of viewable data from a plurality of application programs.

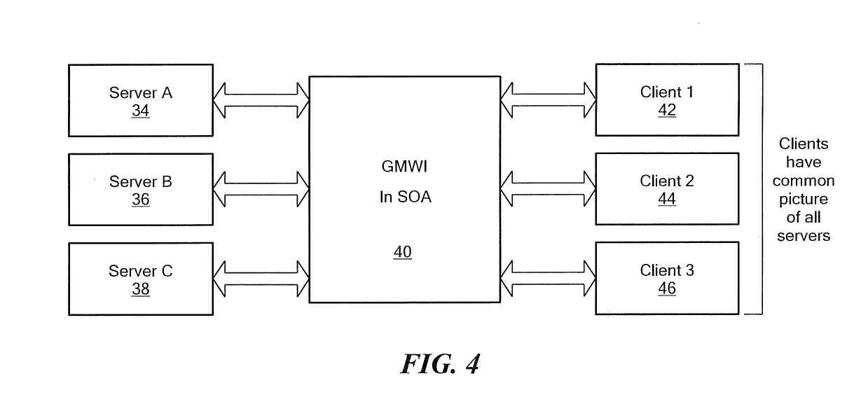

Referring now to FIG. 3, another benefit of the implementation of the GMWI is that a system can re-use any map adapter to display geographical data. If a system 26 has no current implementation for displaying its geographical data, the system can incorporate the GMWI 14. A GMWI compliant system can then choose which GIS would best fit its needs. For example, since GMWI compliant map adapters are available for various GIS's such as OpenMap 28, Falcon View 30, and Google Earth 32, the system can use one or all of these Map Adapters without implementing its own. This greatly reduces development effort and cost, and shows the versatility of the GMWI.

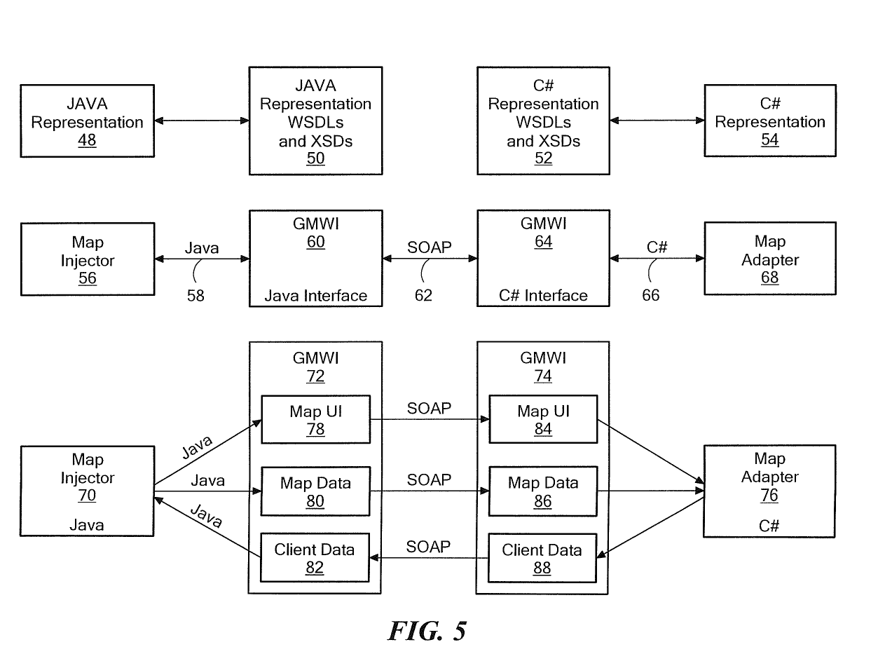

Referring now to FIG. 4, another advantage to the GMWI is the ability to use web services. These web services can be used in a service-oriented architecture (SOA). In the figure, a localized server 40 contains the GMWI and redirects the GMWI interface calls either to all clients 42, 44, 46 connected to the system or to individual clients. When a client connects to this server a globally unique identifier (GUID) is created for that client. When user actions occur for this client it will send this GUID back to the server. This allows the server to determine what client made the request. In the exemplary embodiment of FIG. 4, a localized server 40 is used in a service-oriented architecture (SOA) where many different servers 34, 36, 38 are sending data into the GMWI. Thus the data will be displayed in one common picture on a GIS anywhere in the system.

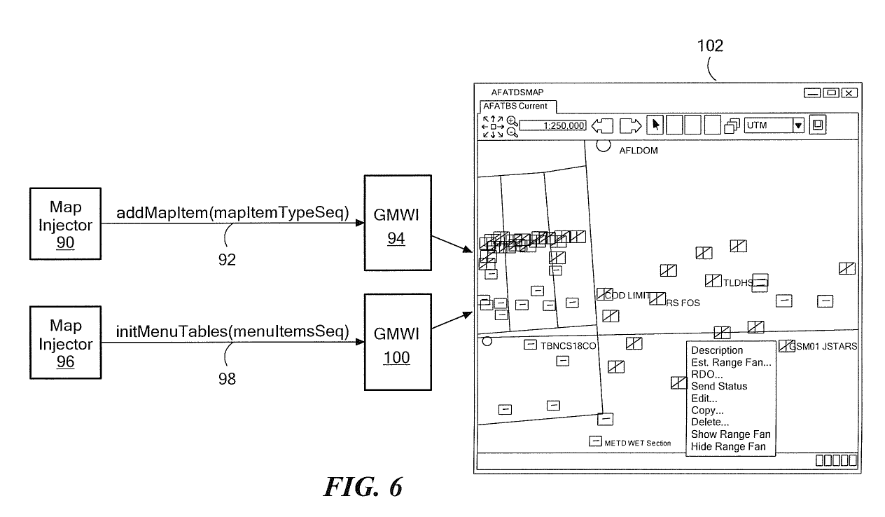

Referring now to FIG. 5, the GMWI uses a web service interface to communicate between a map injector and a map adapter. This interface is defined inside web service definition language (WSDL) files and extensible markup language (XML) schema definition (XSD) files. The WSDL files define the methods and parameters that each map adapter and map injector can use, while the XSD files define the data structures. These files can be created using different languages. For example, a map injector can be written in Java 48 and a Map Adapter can be developed using C# 54. These interface files can then be provided to a developer who can use them to generate stubs or implementation files.

As an example of language interoperability supported in GMWI, FIG. 5 shows a map injector 56 implemented in Java communicating via GMWI to a map adapter 68 implemented in C#. The map injector communicates employing Java 58 to the GMWI Java interface 60. The Java interface employs the SOAP (Simple Object Access Protocol) standard 62, well known in the art, to communicate with the GMWI C# interface 64, which in turn communicates employing C# 66 to the map adapter.

Further explaining FIG. 5, the GMWI 72, 74 contains three APIs. There are two APIs to communicate data to the map adapter, a data API 80, 86 and a user interface (UI) API 78, 84, and there is one client data API 82, 88 for the map adapter to communicate back to the map injector. The map data and client data APIs are designed after an open standard. This standard is based upon the Open Geospatial Consortium Geographic Objects 0.5.0 standard. These API's have not been defined in web services before and are a unique feature of the GMWI. The map UI API defines a way to manipulate the current look and feel of the current Map Adapter and also defines pop-ups and menus for the current map.

The developer can use the interoperability described above to support application programs and GISs implemented in different languages. An example of this communication is shown in FIG. 5. In Java, a developer implementing a map injector can use a Java API for XML Web Services (JAX-WS) to generate the Java stubs of the methods and types defined in the WSDLs and schemas. The Java developer can use the GMWI to communicate with a map adapter written in C#. The C# developer can generate the equivalent methods and data types defined by the WSDLs and schemas. When the Java developer makes a method call on the interface, the generated code makes a web service call to the web service endpoint that the C# map adapter creates.

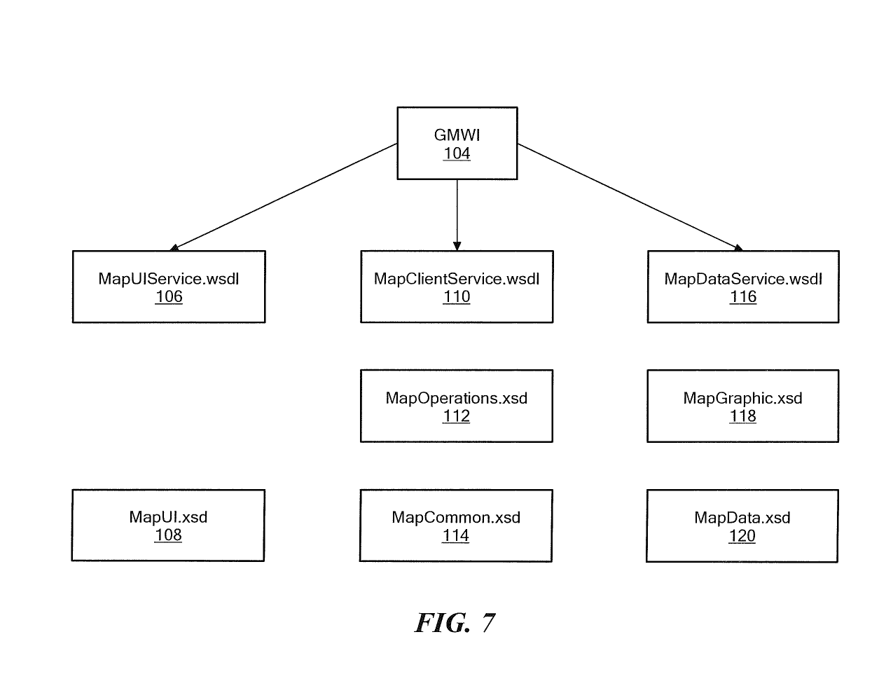

Referring now to FIG. 6, an example of how an interface may look to a developer with a simple call is shown. This example uses the map data service in conjunction with the map GUI service to provide the end-user with a functional way to interact with the displayed entity on the map. The map injector 90 sends an icon that has a right click pop-up menu 102 that is defined by the map injector.

In the example of FIG. 6, we deal with a method declaration of addMapItems 92. This addMapItems method is defined inside the map data services WSDL previously discussed. This method takes a list of MapItemTypes. Each MapItemType contains an assortment of data that both define different ways to represent a map item and adhere to the OGC standards definitions. The map injector populates the required (and optional) fields for this MapItemType and transfers these fields to the GMWI 94. The GMWI Map Adapter receives this data and translates it into information that the map engine within the GIS can process. Since the map injector is sending standardized data to an interface, it has no need for knowledge of the actual mapping engine that will eventually display the data provided.

Expanding on the example, one field inside the MapItemType is a menu id. This menu id ties a map item to a pop-up menu defined by the map GUI services. This call, initMenuTables 98, takes a list of menu items that define both drop down menus from a menu bar as well as pop-ups for individual map items, and transfers them to the GIS 102. When the end user right-clicks on a map item, the map adapter performs a lookup of the menu id given to the map item, and displays the corresponding pop-up menu defined in the UI service.

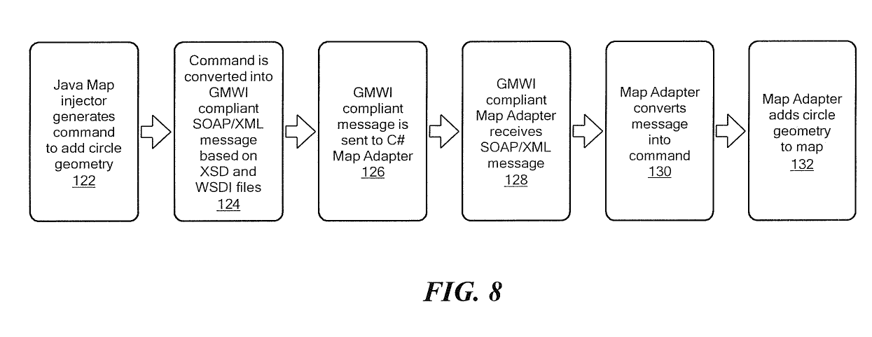

Referring now to FIG. 7, elements of an exemplary GMWI 104 are shown. WSDL's (web services definition language) define methods and parameters declarations, xsd's (XML schema definition) map the data used. The GMWI elements are shown below:

MapUIService.wsdl 106: The definition of the UI services provided by the API.

MapUI.xsd 108: Defines the data the will be passed for the UI services. These data types consist of graphical information that can be used to display data in different format. UI components may be Trees, tables, popup menus, menu bar, buttons, or toolbars.

MapCommon.xsd 114: Defines different types that are common between the different APIs declarations. These data types consist of location types, i.e. geodetic locations, and types used between the MapDataService.wsdl, MapClientService.wsdl, and MapUIServices.

MapClientService.wsdl 110: Defines an interface back to the map injector. This interface can be used to populate windows from points picked from the map adapter, and allow the map adapter to know attributes of the map injector, i.e. scale, map position, user clicks, rubber-banding selections, etc.

MapOperations.xsd 112: Defines the data pass between the map injector and map adapter, such as shut down commands, map items selected, user click, etc.

MapDataService.wsdl 116: The definition of Map Data API's. These API's are mapped to the Open Geospatial Consortium (OGC). These API's will be used to draw geodetic shapes and place geodetic icons onto a GIS mapping engine.

MapGraphic.xsd 118: Defines the types that are used to create these geodetic entities onto a map injector. Types include Arcs, Polygons, Circles, Paths, Lines, etc. Many of these types are mapped after the OGC standard.

MapData.xsd 120: Defines some data used for mapping capabilities, such as overlays, military symbol modifiers and other data.

These GMWI elements can communicate between map injectors and map adapters implemented in different programming languages.

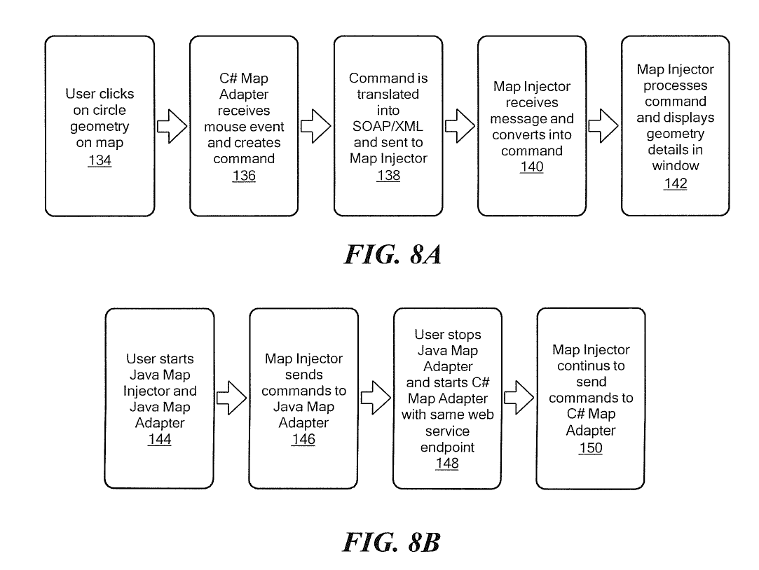

FIGS. 8-8B are flow diagrams showing the processing performed by a processor to exchange data and commands between map adapters and map injectors written in different programming languages.

The rectangular elements (typified by element 122 in FIG. 8) are herein denoted “processing blocks” and represent computer software instructions or groups of instructions. It should be noted that the flow diagrams of FIGS. 8-8B represent one embodiment of the design and variations in such a diagram, which generally follow the process outlined are considered to be within the scope of the concepts described and claimed herein.

Alternatively, the processing blocks represent operations performed by functionally equivalent circuits such as a digital signal processor circuit or an application specific integrated circuit (ASIC) of a field programmable gate array (FPGA). Some processing blocks may be manually performed while other processing blocks may be performed by a processor. The flow diagrams do not depict the syntax of any particular programming language. Rather, the flow diagrams illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence described is illustrative only and can be varied without departing from the spirit of the concepts described and/or claimed herein. Thus, unless otherwise stated, the processes described below are unordered meaning that, when possible, the sequences shown in FIGS. 8-8B can be performed in any convenient or desirable order.

Turning now to FIG. 8, a flow diagram illustrating an exemplary process of a C# map adapter obtaining data from a Java map injector begins as shown in processing block 122 with a Java map injector generating a command to add circle geometry to the map, such as a range fan depicting a radar's range and field of view. As shown in processing block 124, the command is converted into a GMWI compliant SOAP/XML message based on XSD and WSDL files.

Processing then proceeds to processing block 126 in which the GMWI compliant message is sent to a C# map adapter. The GMWI-compliant map adapter receives SOAP/XML message as shown in processing block 128 and the map adapter converts the message into a command 130.

Processing then proceeds to processing block 132 in which the map adapter adds the circle geometry to map.

Referring now to FIG. 8A, a user process begins in processing block 134 in which a user clicks on a circle geometry on a map and as shown in block 136, a C# Map Adapter receives the mouse event and in response thereto creates an appropriate command. The command is translated into SOAP/XML and sent to the appropriate map injector 138. The map injector receives the message and converts it into a command 140 and then the map injector processes the command and displays geometry details in window 142.

Referring now to FIG. 8B, a process for swapping out map adapters while maintaining the current map injector begins as shown in processing block 144 with a user starting a Java map injector and a Java map adapter. As shown in block 146, the map injector sends commands to the Java map adapter (it should be noted that for the purposes of FIG. 8B, the particular commands are irrelevant since the point of this flow diagram is illustrating the ability to swap out map adapters without having to change the map injector). The user stops the Java map adapter and starts C# map adapter with same web service endpoint 148. The map injector continues to send commands to C# map adapter 150.

One of ordinary skilled in the art will recognize that the above process can be implemented with any combination of languages, such as Java to Java, C# to Java, Java To Flex, etc. Further, a plurality of application programs can be written in different languages and communicate to a GIS. For example, referring to FIG. 2, the EMT map injector could be written in Java and the Any System map injector could be written in C#. Further, a plurality of GISs can be written in different languages and communicate to an application program. For example, referring to FIG. 3, Open Map could be written in C++ and Falcon view could be written in Java.

As a further illustration of the operation of the GMWI elements, the software elements below show how a CircleType method is converted by the GMWI into a Java object or C# object as required by the Map Adapter.

The GMWI interface for CircleType is:

```
<xs:complexType name=“CircleType”>
    <xs:annotation>
        <xs:documentation>circle type</xs:documentation>
    </xs:annotation>
    <xs:sequence>
        <xs:element name=“center“ type=“mapcommon:LocationType”/>
        <xs:element name=“radius” type=“mapcommon:RadiusType”/>
    </xs:sequence>
</xs:complexType>
```

The generated java object for CircleType is:

```
@XmlType(name = “CircleType”, propOrder = {
  “center”,
  “radius”
})
public class CircleType {
  @XmlElement(required = true)
  protected LocationType center;
  protected int radius;
```

The generated C# object for CircleType is:

```
[System.Xml.Serialization.XmlTypeAttribute(Namespace=
“http://www.gmiweb.com/schema/mapda
public partial class CircleType
{
  private LocationType centerField;
  private long radiusField;
```

Similarly, the software elements below show how a MapDataService method is converted into a Java object or C# object.

The section of GMWI interface for MapDataService is:

```
<portType name=“MapDataService“>
    <operation name=“setColor“>
        <input message=“tns:setColor”/>
        <output message=“tns:setColorResponse”/>
    </operation>
    <operation name=“setMovability“>
        <input message=“tns:setMovability”/>
        <output message=“tns:setMovabilityResponse”/>
    </operation>
```

The section of generated C# stub for MapDataService is:

```
[System.ServiceModel.ServiceContractAttribute(Namespace=
“http://www.gmiweb.com/wsdl”, ConfigurationName=
“MapDataService”)]
public interface MapDataService
{
  // CODEGEN: Generating message contract since the operation
setColor is neither RPC nor document wrapped.
  [System.ServiceModel.OperationContractAttribute(Action=“”,
  ReplyAction=“*”)]
  [System.ServiceModel.XmlSerializerFormatAttribute( )]
  setColorResponse setColor(setColorRequest request);
  // CODEGEN: Generating message contract since the operation
setMovability is neither RPC nor document wrapped.
  [System.ServiceModel.OperationContractAttribute(Action=“”,
  ReplyAction=“*”)]
  [System.ServiceModel.XmlSerializerFormatAttribute( )]
  setMovabilityResponse setMovability(setMovabilityRequest request);
```

The section of generated Java stub for MapDataService is:

```
@WebService(name = “MapDataService”, targetNamespace =
“http://www.gmiweb.com/wsdl”)
@XmlSeeAlso({
  mil.army.monmouth.webmap.data.ObjectFactory.class,
  mil.army.monmouth.webmap.graphic.ObjectFactory.class,
  mil.army.monmouth.webmap.operations.ObjectFactory.class,
  mil.army.monmouth.webmap.common.ObjectFactory.class,
  mil.army.monmouth.webmap.ui.ObjectFactory.class
})
      public interface MapDataService {
  /**
  *
  * @param mapId
  * @param color
  * @param mapItemId
  */
  @WebMethod
  @RequestWrapper(localName = “setColor”, targetNamespace =
“http://www.gmiweb.com/schema/mapoperations”, className =
“mil.army.monmouth.webmap.operations.SetColor”)
  @ResponseWrapper(localName = “blankResponse”, targetNamespace =
“http://www.gmiweb.com/schema/mapoperations”, className =
“mil.army.monmouth.webmap.operations.BlankResponse”)
  public void setColor(
    @WebParam(name = “mapId”, targetNamespace =
“http://www.gmiweb.com/schema/mapoperations”)
    UniqueIdType mapId,
    @WebParam(name = “mapItemId”, targetNamespace =
“http://www.gmiweb.com/schema/mapoperations”)
    UniqueIdType mapItemId,
    @WebParam(name = “color”, targetNamespace =
“http://www.gmiweb.com/schema/mapoperations”)
    ColorType color);
  /**
  *
  * @param mapId
  * @param moveable
  * @param mapItemIds
  */
  @WebMethod
  @RequestWrapper(localName = “setMovability”, targetNamespace =
“http://www.gmiweb.com/schema/mapoperations”, className =
“mil.army.monmouth.webmap.operations.SetMovability”)
  @ResponseWrapper(localName = “blankResponse”, targetNamespace =
“http://www.gmiweb.com/schema/mapoperations”, className =
“mil.army.monmouth.webmap.operations.BlankResponse”)
  public void setMovability(
    @WebParam(name = “mapId”, targetNamespace =
“http://www.gmiweb.com/schema/mapoperations”)
    UniqueIdType mapId,
    @WebParam(name = “mapItemIds”, targetNamespace =
“http://www.gmiweb.com/schema/mapoperations”)
    MapItemIdTypeSeq mapItemIds,
    @WebParam(name = “moveable”, targetNamespace =
“http://www.gmiweb.com/schema/mapoperations”)
    boolean moveable);
```

One of ordinary skill in the art will see how any other methods can be converted.

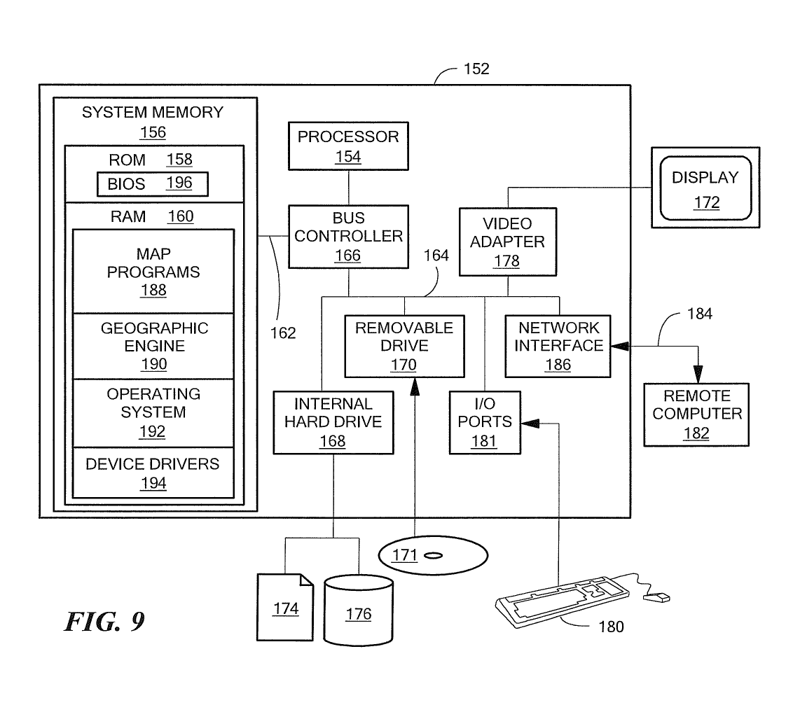

Referring now to FIG. 9, a computer 152 suitable for supporting the operation of an embodiment of the inventive systems, concepts, and techniques described herein includes a processor 154. Processor 154 may, for example, be provided as a dual-core processor, such as the AMD Athlon™ X2 Dual Core processor from the Advanced Micro Devices Corporation. However, it should be understood that computer 152 may use other microprocessors. Computer 152 can represent any server, personal computer, laptop, or even a battery-powered mobile device such as a hand-held personal computer, personal digital assistant, or smart phone.

Computer 152 includes a system memory 156 which is connected to the processor 154 by a system data/address bus 162. System memory 156 includes a read-only memory (ROM) 158 and random access memory (RAM) 160. The ROM 158 represents any device that is primarily read-only including electrically erasable programmable read-only memory (EEPROM), flash memory, etc. RAM 160 represents any random access memory such as Synchronous Dynamic Random Access Memory (SDRAM). The Basic Input/Output System (BIOS) 196 for the computer 152 is stored in ROM 158 and loaded into RAM 160 upon booting.

Within the computer 152, input/output (I/O) bus 164 is connected to the data/address bus 162 via a bus controller 166. In one embodiment, the I/O bus 164 is implemented as a Peripheral Component Interconnect (PCI) bus. The bus controller 166 examines all signals from the processor 154 to route signals to the appropriate bus. Signals between processor 154 and the system memory 156 are passed through the bus controller 166. However, signals from the processor 154 intended for devices other than system memory 156 are routed to the I/O bus 164.

Various devices are connected to the I/O bus 164 including internal hard drive 168 and removable storage drive 170 such as a CD-ROM drive used to read a compact disk 171 or a floppy drive used to read a floppy disk. The internal hard drive 168 is used to store data, such as in files 174 and database 176. Database 176 includes a structured collection of data, such as a relational database. A display 172, such as a cathode ray tube (CRT), liquid-crystal display (LCD), etc. is connected to the I/O bus 164 via a video adapter 178.

A user enters commands and information into the computer 152 by using input devices 180, such as a keyboard and a mouse, which are connected to I/O bus 164 via I/O ports 181. Other types of pointing devices that may be used include track balls, joy sticks, and tracking devices suitable for positioning a cursor on a display screen of the display 172.

Computer 152 may include a network interface 186 to connect to a remote computer 182, an intranet, or the Internet via network 184. The network 184 may be a local area network or any other suitable communications network.

Computer-readable modules and applications 188 and other data are typically stored on memory storage devices, which may include the internal hard drive 168 or the compact disk 171, and are copied to the RAM 160 from the memory storage devices. In one embodiment, computer-readable modules and applications 188 are stored in ROM 158 and copied to RAM 160 for execution, or are directly executed from ROM 158. In still another embodiment, the computer-readable modules and applications 188 are stored on external storage devices, for example, a hard drive of an external server computer, and delivered electronically from the external storage devices via network 184.

The computer-readable modules 188 may include compiled instructions for implementing embodiments of one or more of: a map injector, a map adapter, a GMWI, a mapping application and methods described herein. A map may be rendered and outputted to display 172 to enable users to view the map.

In a further embodiment, the computer 152 may execute various processes on separate processors, such as a first processor and a second processor of a dual core processor. As by way of a non-limiting example, map injector operations (e.g. to receive and respond to user input) may be executed by the first processor and map adapter operations (e.g., to draw a circle geometry on a map) may be executed by the second processor. Alternatively, the first and second processors may be respective first and second computing devices.

The computer 152 may execute a database application 190, such as Oracle™ database from Oracle Corporation, to model, organize, and query data stored in database 176. The data may be used by the computer-readable modules and applications 188 and/or passed over the network 184 to the remote computer 182 and other systems.

In general, the operating system 192 executes computer-readable modules and applications 188 and carries out instructions issued by the user. For example, when the user wants to execute a computer-readable module 188, the operating system 192 interprets the instruction and causes the processor 154 to load the computer-readable module 188 into RAM 160 from memory storage devices. Once the computer-readable module 188 is loaded into RAM 160, the processor 154 can use the computer-readable module 188 to carry out various instructions. The processor 154 may also load portions of computer-readable modules and applications 188 into RAM 160 as needed. The operating system 192 uses device drivers 194 to interface with various devices, including memory storage devices, such as hard drive 168 and removable storage drive 170, network interface 186, I/O ports 181, video adapter 178, and printers.

This document describes inventive concepts, systems and techniques which overcome the limitations of previous mapping systems and techniques. A new system and technique is introduced that allows a map injector to communicate with any of a plurality of GIS's without special coding in the map injector itself, and so is more flexible and is more efficient in development resources.

Having described preferred embodiments of the invention it will now become apparent to those of ordinary skill in the art that many other embodiments incorporating these concepts may be used. Accordingly, it is submitted that that the invention should not be limited to the described embodiments but rather should be limited only by the spirit and scope of the appended claims.

What is claimed is:

1. A data processing system comprising:
one or more application programs;
one or more geographic information systems (GIS) which communicate with each of said one or more application programs; and
a general map web interface (GMWI) which defines the format and structure of data communicated between each of said one or more application programs and said one or more geographic information systems.

2. The data processing system of claim 1 where each of said one or more application programs includes a map injector and each of said one or more geographic information systems includes a map adapter and said GMWI comprises two application programming interface (APIs) for the map injector to communicate to the map adapter and one API for the map adapter to communicate to the map injector.

3. The data processing system of claim 2 where the two APIs to communicate data to the map adapter correspond to a map data API and a map user interface (UI) API.

4. The data processing system of claim 3 where the map data API and the map adapter to map injector API are based upon the Open Geospatial Consortium Geographic Objects 0.5.0 standard.

5. The data processing system of claim 3 where the map UI API defines a way to manipulate the current look and feel of a current map adapter and also defines pop-ups and menus for a current map.

6. The data processing system of claim 1 where said interface defines the format and structure of graphical data communicated between each of said one or more application programs and said one or more geographic information systems.

7. The data processing system of claim 1 where said interface defines the format and structure of geographic data communicated between each of said one or more application programs and each of said one or more geographic information systems.

8. The data processing system of claim 1 where said interface is comprised of files, which define methods, parameters, and data structures.

9. The data processing system of claim 8 where said interface is comprised of web service definition language (WSDL) files, which define methods and parameters, and extensible markup language (xsd) files, which define the data structures.

10. The system of claim 1 wherein each of said one or more application programs includes a map injector and each of said one or more geographic information systems includes a map adapter and wherein the interface uses a web service interface to communicate between the map injector and the map adapter and wherein web service interface is defined inside web service definition language (WSDL) files and extensible markup language (XML) schema definition (XSD) files wherein the WSDL files define the methods and parameters that each map adapter and map injector can use and the XSD files define the data structures.

11. The data processing system of claim 1 where each of said one or more geographic information systems are adapted to display information in accordance with commands and data received from said application program or programs.

12. The data processing system of claim 1 where communication between at least one geographic information system and at least one application program occurs between programs running on the same physical computer.

13. The data processing system of claim 1 where communication between at least one geographic information system and at least one application program occurs between programs running on different computers, which communication may occur over a local area network or an Internet.

14. The data processing system of claim 1 wherein at least one application program is implemented in a programming language which is different than a programming language in which at least one geographic information system is implemented.

15. The data processing system of claim 1 wherein at least two application programs, implemented in different programming languages, can communicate with the same GIS and wherein at least two GISs implemented in different programming languages can communicate with the same application program.

16. A method of communicating between one or more application programs and one or more geographic information systems, the method comprising:
providing one or more application programs;
providing one or more geographic information systems (GIS) which communicate with at least one of said one or more application programs; and
providing an interface which defines the format and structure of data communicated between each of said one or more application programs and said one or more geographic information systems.

17. The method of claim 16 where each of said one or more application programs includes a map injector and each of said one or more geographic information systems includes a map adapter and said GMWI comprises two application programming interface (APIs) for the map injector to communicate data to the map adapter and one API for the map adapter to communicate to the map injector.

18. The method of claim 17 where the two APIs to communicate data to the map adapter correspond to a map data API and a map user interface (UI) API.

19. The method of claim 18 where the map data API and client data API are based upon the Open Geospatial Consortium Geographic Objects 0.5.0 standard.

20. The method of claim 18 where the map UI API defines a way to manipulate the current look and feel of a current map adapter and also defines pop-ups and menus for a current map.

21. The method of claim 16 wherein said interface defines the format and structure of graphical data communicated between each of said one or more application programs and each of said one or more geographic information systems.

22. The method of claim 16 wherein said interface defines the format and structure of geographic data communicated between each of said one or more application programs and said one or more geographic information systems.

23. The method of claim 16 wherein said interface is comprised of files, which define methods, parameters, and data structures.

24. The method of claim 22 wherein said interface is comprised of web service definition language (WSDL) files, which define methods and parameters, and extensible markup language (XML) files, which define the data structures.

25. The method of claim 15 wherein each of said one or more application programs includes a map injector and each of said one or more geographic information systems includes a map adapter and wherein the interface uses a web service interface to communicate between the map injector and the map adapter and wherein web service interface is defined inside web service definition language (WSDL) files and extensible markup language (XML) schema definition (XSD) files wherein the WSDL files define the methods and parameters that each map adapter and map injector can use and the XSD files define the data structures.

26. The method of claim 15 wherein each of said one or more geographic information systems are adapted to display information in accordance with commands and data received from said application program or programs.

27. The method of claim 15 wherein communication between at least one geographic information system and at least one application program occurs between programs running on the same physical computer.

28. The method of claim 15 wherein communication between at least one geographic information system and at least one application program occurs between programs running on different computers, which communication may occur over a local area network or an internet.

29. The method of claim 15 wherein at least one application program is implemented in a programming language which is different than a programming language in which at least one geographic information system is implemented.

30. The method of claim 15 wherein at least two application programs, implemented in different programming languages, can communicate with the same GIS and wherein at least two GISs implemented in different programming languages can communicate with the same application program.
